(19) United States
(12) Patent Application Publication
(10) Pub. No.: US 2019/0224519 A1
(43) Pub. Date: Jul. 25, 2019

(54) RESISTIVE SLIDING EXERCISE APPARATUS AND METHOD

(71) Applicants: Ronald Lloyd Regular, Beaumont (CA); Carly Regular, Beaumont (CA)

(72) Inventors: Ronald Lloyd Regular, Beaumont (CA); Carly Regular, Beaumont (CA)

(21) Appl. No.: 15/879,422

(22) Filed: Jan. 24, 2018

(51) Int. Cl. A63B 21/00; A63B 21/075; A63B 69/00; G09B 19/00; A63B 23/02; A63B 23/04; A63B 21/02; A63B 21/068

(52) U.S. Cl. CPC A63B 21/4045; A63B 21/4034; A63B 21/075; A63B 21/4039; A63B 69/0057; G09B 19/0038; A63B 2225/09; A63B 23/0405; A63B 21/023; A63B 21/00069; A63B 21/068; A63B 2225/093; A63B 23/0233

(57) ABSTRACT

An exercise apparatus includes a base platform, first and second guide rails, first and second footwells, at least one grasping member, and a resistance device. The first guide rail is disposed on a corresponding first side of the base platform, while the second guide rail is disposed on a corresponding second side of the base platform, such that the second guide rail is parallel to the first guide rail. The first footwell is attached to the first guide rail and can slide along the first guide rail. Likewise, the second footwell attached to the second guide rail and can slide along the second guide rail. The first and second footwells are each configured to receive a foot of the user, such that the user may stand upon the two footwells.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of exercise machines of existing art and more specifically relates to resistance exercise equipment.

### Related Art

An exercise machine is a type of equipment used for physical exercise, such as cardiovascular training and strength training. Exercise machines include a wide variety of mechanical devices, such as stationary bicycles, treadmills, and elliptical machines. Usually, exercise machines incorporate some form of fixed or adjustable resistance to enhance the strength or conditioning effects of exercise. Exercise machines may also be useful for providing structures enabling users to exercise muscle groups that are uneasy to use in normal, unassisted exercise.

Often, particular muscle groups may be neglected in an exercise machine due to lack of suitable machines specializing in those muscle groups. Many popular machines only exercise a small portion of muscles, and do not provide a well-rounded workout experience. A suitable solution is desired.

U.S. Pat. No. 4,684,121 to Sander C. Nestergard relates to a multiple exercise unit. The described multiple exercise unit includes an exercise device for simulating several outdoor sports which is made portable and convenient by using a rectangular frame with parallel rails and two roller members which can move independently along the rails to simulate skiing or together as a rowing seat and handle members cooperate with the respective exercise.

### SUMMARY OF THE INVENTION

In view of the foregoing disadvantages inherent in the known resistance exercise equipment art, the present disclosure provides a novel resistive sliding exercise apparatus and method. The general purpose of the present disclosure, which will be described subsequently in greater detail, is to provide an efficient and effective resistive sliding exercise apparatus and method.

An exercise apparatus is disclosed herein. The exercise apparatus includes a base platform, first and second guide rails, first and second footwells, at least one grasping member, and a resistance device. The exercise apparatus is configured for strengthening a user's muscles, particularly the back, legs, and core muscles. The base platform is configured to rest upon a flat surface. The first guide rail is disposed on a corresponding first side of the base platform, while the second guide rail is disposed on a corresponding second side of the base platform, such that the second guide rail is parallel to the first guide rail. The first footwell is attached to the first guide rail and can slide along the first guide rail. Likewise, the second footwell attached to the second guide rail and can slide along the second guide rail. The first and second footwells are each configured to receive a (respective) foot of the user, such that the user may stand upon the two footwells (left and right with respective foot to match side). The grasping member is attached to a front end of the base platform, and extends upwardly from the base platform in such a way that it can be grasped by the user standing on the two footwells. The first footwell and the second footwell are pulled by gravity naturally against the user's action.

According to another embodiment, a method of strengthening a user's back, core, and leg muscles is also disclosed herein. The method of strengthening a user's back, core, and leg muscles includes firstly, providing the described exercise apparatus; secondly, standing on the exercise apparatus, such that the user is standing upon the two footwells facing toward the grasping member; thirdly, placing the user's hands on the grasping member; fourthly, pulling the user's self toward the front end of the base platform; fifthly, relaxing the user's self, such that the user is pulled toward the front end of the platform by the resistance device acting upon the first footwell and the second footwell; and sixthly, repeating the process of pulling and relaxing.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a resistive sliding exercise apparatus and method, constructed and operative according to the teachings of the present disclosure.

FIG. 1 is a perspective view of the exercise apparatus during an ‘in-use’ condition, according to an embodiment of the disclosure.

FIG. 2 is a perspective view of the exercise apparatus of FIG. 1, according to an embodiment of the present disclosure.

FIG. 3 is a perspective view of the exercise apparatus of FIG. 1, according to an embodiment of the present disclosure.

FIG. 4 is a perspective view of the exercise apparatus of FIG. 1, according to an embodiment of the present disclosure.

FIG. 5 is a flow diagram illustrating a method of use for strengthening a user's back, core, and leg muscles, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to resistance exercise equipment and more particularly to a resistive sliding exercise apparatus and method as used to improve the strengthening of a user's back, core, and leg muscles.

Generally, the disclosed exercise apparatus comprises a machine for strengthening a user's muscles, particularly the back, core, and leg muscles. However, the machine may be used for other applications as well. The machine is designed to rest on a horizontal surface, such as a gym floor, and to be used in a fixed position. The machine operates using two footwells that slide upon respective parallel rails. The user may stand upon the two footwells while using the exercise apparatus. Preferably, the footwells are arranged so that the user faces towards the grasping member when standing on the footwells, facing away from the high side of the sloped guide rails. The user may then grasp the grasping member and push themselves backwards along the length of the exercise apparatus, sliding along the rails. In various embodiments, the movement of the footwells may be resisted by a resistance mechanism, such as a spring or weights or the like. Other forms of resistance means may be used. Alternatively, the weight of the user may serve as the resistance device. In order to provide increased resistance, the rails may be sloped, such that the user has to pull against gravity to reach the end of the travel of the footwells. This exercise may be repeated to continually strengthen the user's muscles. Various methods of exercise may be user, such as pulling the user's self while keeping the user's legs fixed, alternating movement of the legs in a walking motion, or other repetitive motions.

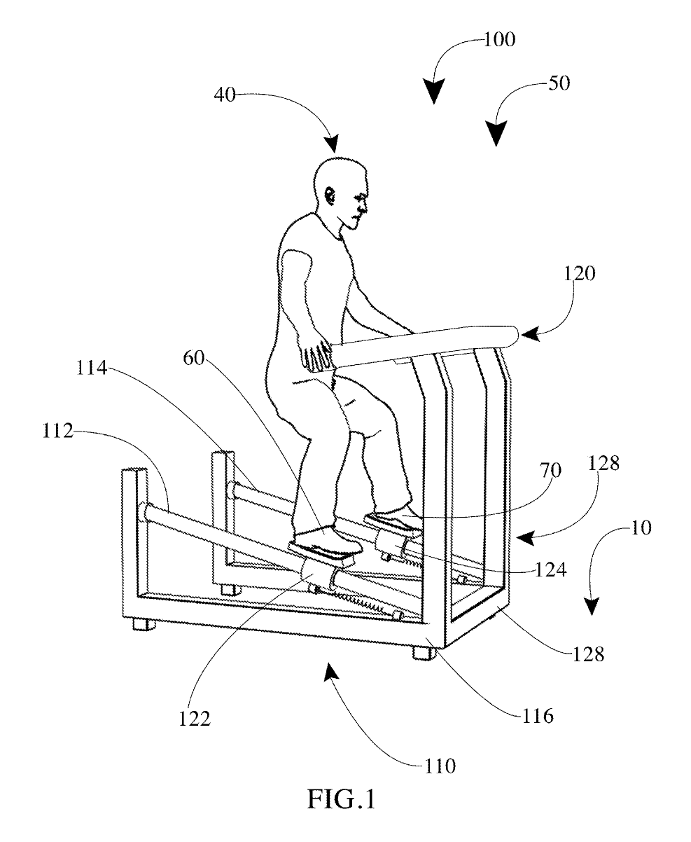

Referring now more specifically to the drawings by numerals of reference, there is shown in FIGS. 1-4, various views of an exercise apparatus 100.

FIG. 1 shows an exercise apparatus 100 during an ‘in-use’ condition 50, according to an embodiment of the present disclosure. Here, the exercise apparatus 100 may be beneficial for use by a user 40 to strengthen a user's back, core, and leg muscles. As illustrated, the exercise apparatus 100 may include base platform 110, first guide rail 112, second guide rail 114, first footwell 122, second footwell 124, at least one grasping member 120, and resistance device 130. Base platform 110 may be configured to rest upon substantially horizontal surface 10. First guide rail 112 may be disposed on first side 116 of base platform 110, while second guide rail 114 may be disposed on second side 118 of base platform 110, such that second guide rail 114 is parallel to first guide rail 112.

First footwell 122 may be attached to first guide rail 112, being configured to slide along first guide rail 112. First footwell 122 may be further configured to receive (respective) foot 60 of user 40. Likewise, second footwell 124 may be attached to second guide rail 114, being configured to slide along second guide rail 114, and may be further configured to receive another (respective) foot 70 of user 40. At least one grasping member 120 may be attached to front end 128 of base platform 110, and extends upwardly from base platform 110 such that it may be grasped by user 40 when user 40 is standing on first footwell 122 and second footwell 124. Resistance device 130 may be affixed to first footwell 122 and second footwell 124, being configured to pull first footwell 122 and second footwell 124 away from front end 128 of base platform 110. First footwell 122 and second footwell 124 may be oriented such that user 40 faces away from front end 128 of base platform 110 when user 40 is using exercise apparatus 100. Upon reading this specification, it should be appreciated that, under appropriate circumstances, considering such issues as user preferences, design preference, structural requirements, marketing preferences, cost, available materials, technological advances, etc., other structural arrangements such as, for example, alternative base designs, footwell designs, handle structures, etc., may be sufficient.

According to one embodiment, the exercise apparatus 100 may be arranged as a kit 105. In particular, the exercise apparatus 100 may further include a set of instructions 107. The instructions 107 may detail functional relationships in relation to the structure of the exercise apparatus 100 such that the exercise apparatus 100 can be used, maintained, or the like, in a preferred manner.

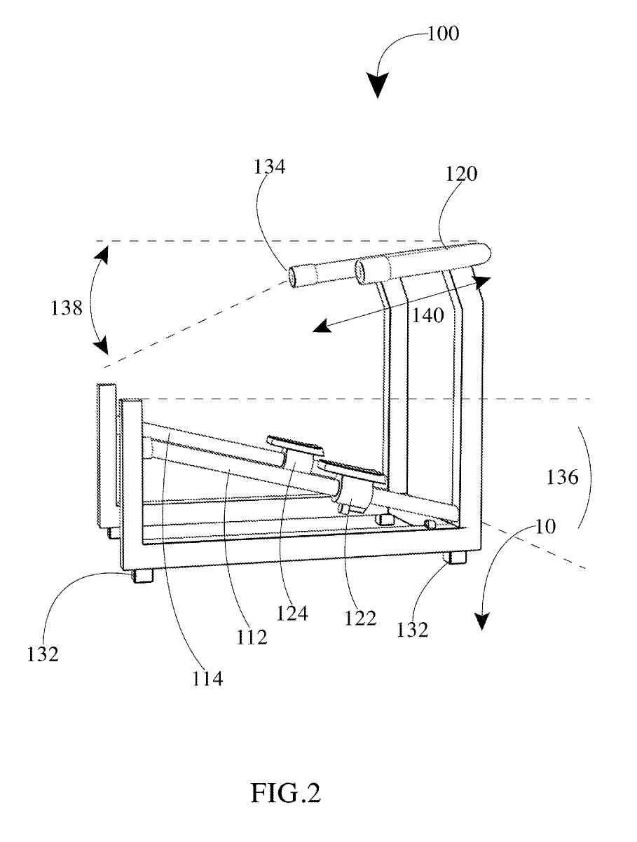

Referring now to FIG. 2 showing the exercise apparatus 100 of FIG. 1, according to an embodiment of the present disclosure. As above, the exercise apparatus 100 may include first guide rail 112, second guide rail 114, first footwell 122, second footwell 124, at least one grasping member 120, and resistance device 130. Base platform 110 (FIG. 1) may further include four feet 132 configured to support exercise apparatus 100 upon substantially horizontal surface 10. Four feet 132 may be adjustable. At least one grasping member 120 may further include at least one ergonomic grip 132 configured to be grasped by user 40 (FIG. 1) during use of exercise apparatus 100. Resistance device 130 may be adjustable, such that a resistance of exercise apparatus 100 is user-selectable. Slope 136 of first guide rail 112 and second guide rail 114 may be adjustable, such that slope 136 of first guide rail 112 and second guide rail 114 is user-selectable. Angle 138 of at least one grasping member 120 may be adjustable, such that angle 138 of at least one grasping member 120 is user-selectable. Length 140 of at least one grasping member 120 may be adjustable, such that length 140 of at least one grasping member 120 is user-selectable.

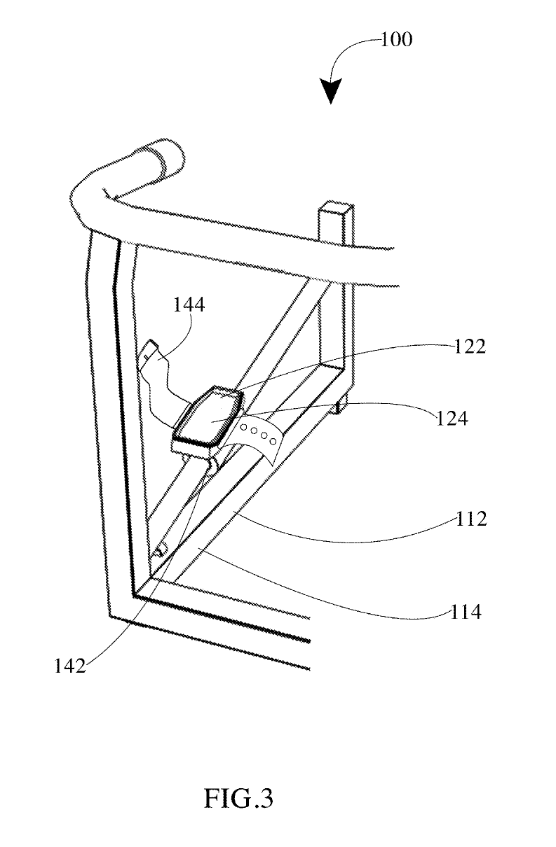

FIG. 3 is a perspective view of the exercise apparatus 100 of FIG. 1, according to an embodiment of the present disclosure. First footwell 122 and second footwell 124 may each further include foot-retaining device 144 configured to fasten (respective) foot 60 (FIG. 1) of user 40 (FIG. 1) to first footwell 122 and second footwell 124. First footwell 122 and second footwell 124 may each open upwardly, and may each include sidewalls 142 configured to prevent movement of a respective foot 60 (FIG. 1) outside of first footwell 122 and second footwell 124 when user 40 (FIG. 1) is using exercise apparatus 100. First footwell 122, second footwell 124, and sidewalls 142 of first footwell 122 and second footwell 124 may be contoured to the shape of (respective) foot 60 (FIG. 1). Sidewalls 142 of first footwell 122 and second footwell 124 may be adjustable, sidewalls 142 of first footwell 122 and second footwell 124 being configured to adapt to disparately sized feet.

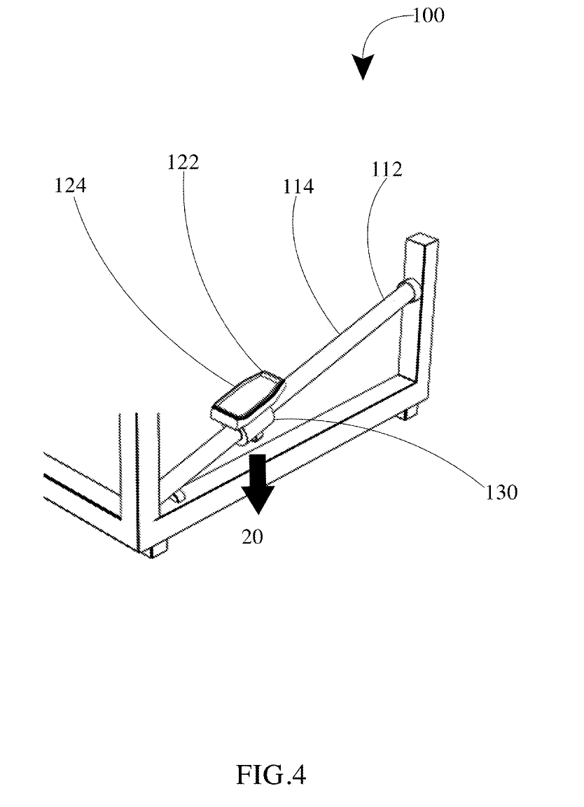

Referring now to FIG. 4 showing a perspective view of the exercise apparatus 100 of FIG. 1, according to an embodiment of the present disclosure. Resistance device 130 may include at least one free weight configured to resist movement of first footwell 122 and second footwell 124 as first footwell 122 and second footwell 124 slide along first guide rail 112 and second guide rail 114. First guide rail 112 and second guide rail 114 may be sloped, first guide rail 112 and second guide rail 114 being configured to provide resistance against movement of user 40 (FIG. 1) while pulling first footwell 122 and second footwell 124 up first guide rail 112 and second guiderail against gravity 20.

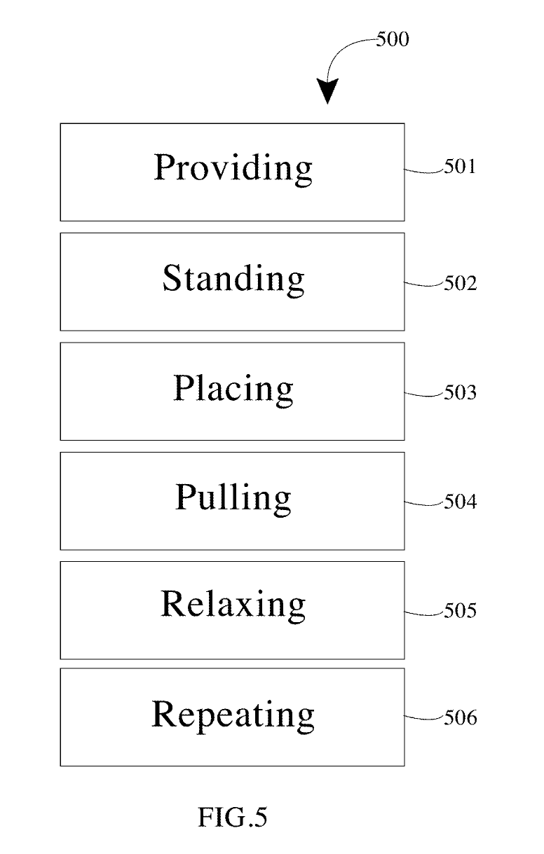

FIG. 5 is a flow diagram illustrating a method for strengthening a user's back, core, and leg muscles 500, according to an embodiment of the present disclosure. In particular, the method for strengthening a user's back, core, and leg muscles 500 may include one or more components or features of the exercise apparatus 100 as described above. As illustrated, the method for strengthening a user's back, core, and leg muscles 500 may include the steps of: step one 501, providing an exercise apparatus for strengthening a user's muscles comprising a base platform configured to rest upon a substantially horizontal surface, a first guide rail disposed on a first side of the base platform, a second guide rail disposed on a second side of the base platform, the second guide rail being parallel to the first guide rail, a first footwell attached to the first guide rail configured to slide along the first guide rail, a second footwell attached to the second guide rail configured to slide along the second guide rail, at least one grasping member attached to a front end of the base platform, the at least one grasping member extending upwardly from the base platform such that it may be grasped by the user while standing on the first footwell and the second footwell, and a resistance device configured to pull the first footwell and the second footwell away from the front end of the base platform; step two 502, standing on the exercise apparatus, such that a first foot of the user is placed upon the first footwell, and such that a second foot of the user is placed upon the second footwell, and such that the user is facing toward the front end of the base platform; step three 503, placing a first hand of the user and a second hand of the user on the at least one grasping member; step four 504, pulling the user's self toward the front end of the base platform; step five 505, relaxing the user's self, such that the user is toward the front end of the platform; and step six 506 repeating the process of pulling and relaxing.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for strengthening a user's back, core, and leg muscles, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An exercise apparatus for strengthening a user's muscles, the apparatus comprising:
a base platform configured to rest upon a substantially horizontal surface;
a first guide rail disposed on a first side of the base platform;
a second guide rail disposed on a second side of the base platform, the second guide rail being parallel to the first guide rail;
a first footwell attached to the first guide rail configured to slide along the first guide rail configured to receive a foot of the user;
a second footwell attached to the second guide rail configured to slide along the second guide rail configured to receive another foot of the user; and
at least one grasping member attached to a front end of the base platform, the at least one grasping member extending upwardly from the base platform such that it may be grasped by the user while standing on the first footwell and the second footwell.

2. The exercise apparatus of claim 1, wherein the resistance device comprises at least one free weight configured to resist movement of the first footwell and the second footwell.

3. The exercise apparatus of claim 1, wherein the base platform further includes four feet configured to support the exercise apparatus upon the substantially horizontal surface.

4. The exercise apparatus of claim 4, wherein the four feet of the base platform are adjustable.

5. The exercise apparatus of claim 1, wherein the at least one grasping member further includes at least one ergonomic grip configured to be grasped by the user during use of the exercising apparatus.

6. The exercise apparatus of claim 1, wherein the first guide rail and the second guide rail are sloped, the first guide rail and the second guide rail being configured to provide resistance against the user's movement as the user pulls the first footwell and the second footwell up the first guide rail and the second guiderail against gravity.

7. The exercise apparatus of claim 1, wherein the resistance device is adjustable, such that a resistance of the exercise apparatus is user-selectable.

8. The exercise apparatus of claim 1, wherein a slope of the first guide rail and the second guide rail is adjustable, such that the slope of the first guide rail and the second guide rail is user-selectable.

9. The exercise apparatus of claim 1, wherein an angle of the at least one grasping member is adjustable, such that the angle of the at least one grasping member is user-selectable.

10. The exercise apparatus of claim 1, wherein a length of the at least one grasping member is adjustable, such that the length of the at least one grasping member is user-selectable.

11. The exercise apparatus of claim 1, wherein the first footwell and the second footwell each comprise an upwardly-opening receptacle having sidewalls configured to prevent movement of a respective said foot of the user outside of the first footwell and second footwell when the user is using the exercise apparatus.

12. The exercise apparatus of claim 12, wherein the first footwell, the second footwell, and the sidewalls of the first footwell and the second footwell are contoured to the shape of the foot of the user.

13. The exercise apparatus of claim 12, wherein the sidewalls of the first footwell and the second footwell are adjustable, the sidewalls of the first footwell and the second footwell being configured to adapt to disparately sized feet.

14. The exercise apparatus of claim 1, wherein the first footwell and the second footwell are oriented such that the user faces away from the front end of the base platform when the user is using the exercise apparatus.

15. The exercise apparatus of claim 1, wherein the first footwell and the second footwell each further include a foot-retaining device configured to fasten the foot of the user to the first footwell and the second footwell.

16. An exercise apparatus for strengthening a user's muscles comprising:
a base platform configured to rest upon a substantially horizontal surface;
a first guide rail disposed on a first side of the base platform;
a second guide rail disposed on a second side of the base platform, the second guide rail being parallel to the first guide rail;
a first footwell attached to the first guide rail configured to slide along the first guide rail configured to receive a foot of the user;
a second footwell attached to the second guide rail configured to slide along the second guide rail configured to receive another foot of the user; and
at least one grasping member attached to a front end of the base platform, the at least one grasping member extending upwardly from the base platform such that it may be grasped by the user while standing on the first footwell and the second footwell;
wherein the base platform further includes four feet configured to support the exercise apparatus upon the substantially horizontal surface;
wherein the four feet of the base platform are adjustable;
wherein the at least one grasping member further includes at least one ergonomic grip configured to be grasped by the user during use of the exercising apparatus;
wherein the first guide rail and the second guide rail are sloped, the first guide rail and the second guide rail being configured to provide resistance against the user's movement as the user pulls the first footwell and the second footwell up the first guide rail and the second guiderail against gravity;
wherein the resistance device is adjustable, such that a resistance of the exercise apparatus is user-selectable;
wherein a slope of the first guide rail and the second guide rail is adjustable, such that the slope of the first guide rail and the second guide rail is user-selectable;
wherein an angle of the at least one grasping member is adjustable, such that the angle of the at least one grasping member is user-selectable;
wherein a length of the at least one grasping member is adjustable, such that the length of the at least one grasping member is user-selectable;
wherein the first footwell and the second footwell each comprise an upwardly-opening receptacle having sidewalls configured to prevent movement of a respective said foot of the user outside of the first footwell and second footwell when the user is using the exercise apparatus;
wherein the first footwell, the second footwell, and the sidewalls of the first footwell and the second footwell are contoured to the shape of a respective said foot of the user;
wherein the first footwell and the second footwell are oriented such that the user faces toward the front end of the base platform when the user is using the exercise apparatus; and
wherein the first footwell and the second footwell each further include a foot-retaining device configured to fasten a respective said foot of the user to each of the first footwell and the second footwell.

17. The exercise apparatus of claim 17, further comprising set of instructions; and
wherein the exercise apparatus is arranged as a kit.

18. A method of strengthening a user's back, core, and leg muscles, the method comprising the steps of:
providing an exercise apparatus for strengthening a user's muscles comprising a base platform configured to rest upon a substantially horizontal surface, a first guide rail disposed on a first side of the base platform, a second guide rail disposed on a second side of the base platform, the second guide rail being parallel to the first guide rail, a first footwell attached to the first guide rail configured to slide along the first guide rail, a second footwell attached to the second guide rail configured to slide along the second guide rail, and at least one grasping member attached to a front end of the base platform, the at least one grasping member extending upwardly from the base platform such that it may be grasped by the user while standing on the first footwell and the second footwell;
standing on the exercise apparatus, such that a first foot of the user is placed upon the first footwell, and such that a second foot of the user is placed upon the second footwell, and such that the user is facing toward the front end of the base platform;
placing a first hand of the user and a second hand of the user on the at least one grasping member;
pulling the user's self toward the front end of the base platform;
relaxing the user's self, such that the user is pulled toward the front end of the platform upon the first footwell and the second footwell; and
repeating the process of pulling and relaxing.
